(19) United States
(12) Patent Application Publication
(10) Pub. No.: US 2005/0254633 A1
(43) Pub. Date: Nov. 17, 2005

(54) Time division multiple access over voice line

(76) Inventor: Chun-Hung Chen, Hsin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/151,438

(22) Filed: Jun. 14, 2005

(30) Foreign Application Priority Data
May 11, 2004 (TW) 93217735

(51) Int. Cl. H04M 1/24

(52) U.S. Cl. 379/90.01

(57) ABSTRACT

A time division multiple access over voice line comprises a telephone line and at least a communication equipment. Signals are transmitted via the telephone line to the communication equipment. The communication equipment comprises a coupler, a filter, an IC and a microprocessor. Digitized voice or data are transmitted via an existent telephone line to the communication equipment by means of phase shift keying to accomplish the effects of multiple internal lines and multi-channel control and also realize the object of resources sharing.

### BACKGROUND OF THE INVENTION

1. Field of the Invention

The present invention relates to a voice line system and, more particularly, to a time division multiple access over voice line.

2. Description of Related Art

On the development of message communication, people always hope to transmit as many messages as possible in the shortest time. From previous messenger, phototelegraphy, teletypewriter, telephone and fax to present electronic mail via the Internet, various kinds of communication ways have evolved to seek faster transmission of higher quality. The more people transmit and receive messages, however, the more messages they want.

The conventional telephone system provides a voice exchange service between two points connected by a telephone line. The transmitted content is usually an analog signal. Along with the prosperity of the information technology, the transmission of voice or data becomes more and more frequent. Telephone switching systems thus are used to provide simultaneous use of telephone service by multiple people. Conventional telephone switching systems, however, are expensive. It is also necessary for technical staff to make the setting on the spot such as station telephone numbers and station lines, hence causing much inconvenience in use.

In order to transmit voice and data on a telephone line by means of conventional analog modulation methods, it is necessary to use several sets of hardware circuits due to the limit of analog modulation, hence resulting in the problems of large size, high price and mutual interference. This also restricts the range and flexibility of applications.

### SUMMARY OF THE INVENTION

One object of the present invention is to provide a time division multiple access over voice line (TDOV), which provides at least a data box to realize multiple internal lines and also accomplish the effect of multi-channel control of signal.

Another object of the present invention is to implement the functions of a conventional telephone switching system on a communication equipment used so as to save the number of hardware components for lowering the cost.

Yet another object of the present invention is to provide a voice line system with a simple circuit for convenient operation of user.

To achieve the above objects, the present invention provides a time division multiple access over voice line, which comprises a telephone line and at least a communication equipment. A signal is transmitted via the telephone line to the communication equipment. The communication equipment comprises a coupler for signal transmission, a filter for filtering out signal noise, an IC formed by integrating several electronic circuits, and a microprocessor having a program for controlling actions of the IC.

### BRIEF DESCRIPTION OF THE DRAWINGS

The various objects and advantages of the present invention will be more readily understood from the following detailed description when read in conjunction with the appended drawing, in which:

FIG. 1 is a structure block diagram of the present invention; and

FIG. 2 is a block diagram according to an embodiment of the present invention.

### DETAILED DESCRIPTION OF THE PREFERRED EMBODIMENTS

The present invention makes use of phase shift keying to transmit digitized voice or data via an existent telephone line to a communication equipment to accomplish multiple internal lines and multi-channel control and also realize the object of resources sharing.

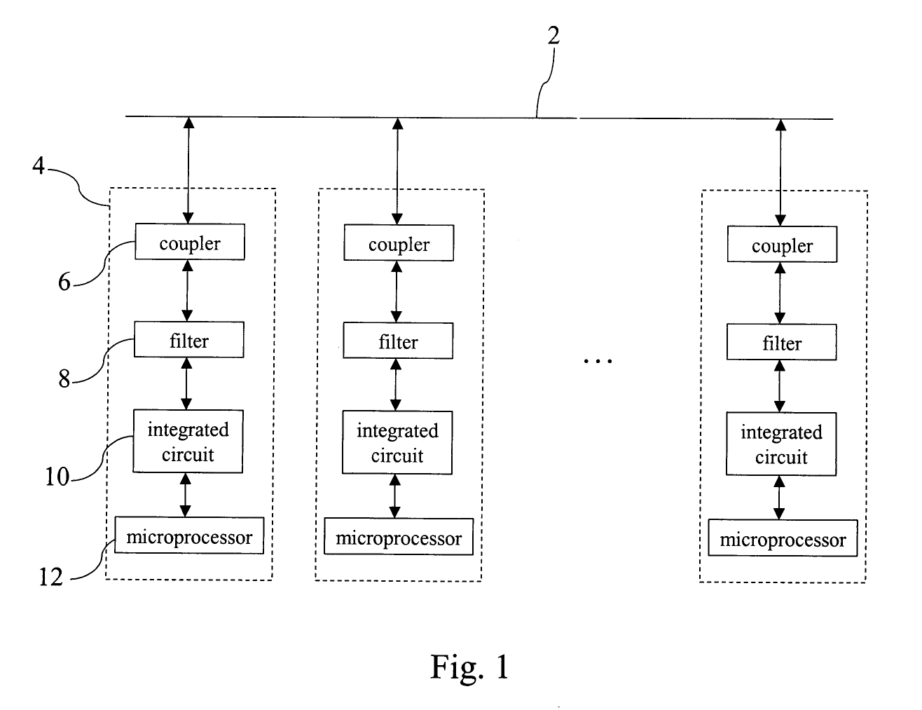

As shown in FIG. 1, a time division multiple access over voice line comprises a telephone line 2 and at least a communication equipment 4. The telephone line 2 and the communication equipment are connected together. A signal is transmitted via the telephone line 2 to the communication equipment 4. The communication equipment 4 provides at least a data box to store the signal of the telephone line 2.

The communication equipment 4 comprises a coupler 6, a filter 8, an IC 10 and a microprocessor 12. The coupler 6 is used for signal transmission of the telephone line 2. The coupler 6 couplers the signal to the telephone line 2 or a voice line so that the signal can be simultaneously transmitted with voice without mutual interference. The filter 8 is used for filtering out noise of the signal. The IC 10 is specifically designed and is formed by integrating several electronic circuits. The microprocessor 12 has an internal program for controlling actions of the IC 10.

The telephone line 2 is connected to at least a communication equipment 4 to accomplish multiple access. Time division multiple access (TDMA) is applied to voice lines for control of the bandwidth resource. In TDMA, the bandwidth is first sliced into several smaller bands. Each band is then sliced into equal slots. Several slits are then combined to form a frame. The first slot of each frame forms a first channel of TDMA, and so on. Each channel is used by a user. In this way, signals of different users won't overlap each other. Therefore, the communication equipment 4 can realize multi channels to accomplish multi-channel control of the signal of the telephone line 2. Moreover, the communication equipment 4 provides at least a data box to store the signal of the telephone line 2.

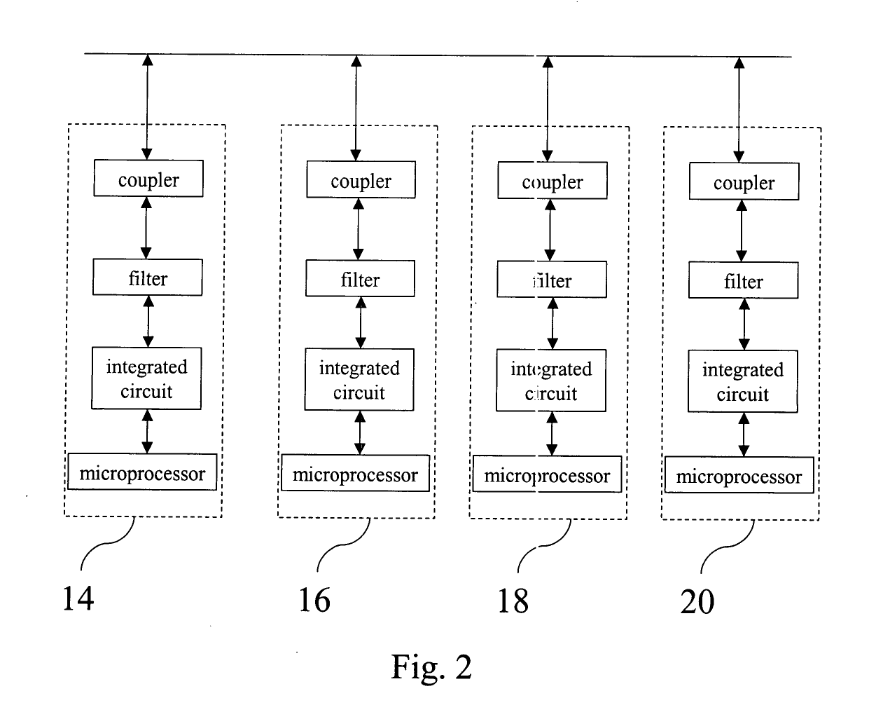

As shown in FIG. 2, the TDOV has a first communication equipment 14, a second communication equipment 16, a third communication equipment 18 and a fourth communication equipment 20. These four communication equipments achieve signal connection and accomplish the following operation effects:

(1) No mutual interference: The first communication equipment 14 can communicate with the second communication equipment 16. At the same time, the third communication equipment 18 can communicate with the fourth communication equipment 20. Therefore, simultaneous use of communication equipments by several users can be accomplished.

(2) Resources sharing: If the fourth communication equipment 20 is a telephone recorder, the first, second and third communication equipments 14, 16 and 18 can access the messages of the telephone recorder through the TDOV. That is, each communication equipment has the function of telephone recorder.

(3) Exchange: When one answers the phone using the first communication equipment 14 but finds it is indeed the third communication equipment 18 to be communicated, he can reserve this signal and then ring the third communication equipment through the TDOV, hence accomplishing the function of switching.

To sum up, the present invention implements the conventional telephone switching function on a communication equipment that is used and provides at least a data box to realize multiple internal lines and multi-channel control of telephone signal. Several people can simultaneously utilize communication equipments without mutual interference. Moreover, the circuit is simple to save the trouble of wiring of station lines and also lower the cost. The present invention applies to places requiring the switching function without a switching machine, especially to common families and small offices.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

1. A time division multiple access over voice line carrying out signal transmission by means of phase shift keying, said time division multiple access over voice line comprising a telephone line and at least a communication equipment, said telephone line being used to transmit a signal to said communication equipment, said communication equipment comprising:
a coupler for transmission of said telephone line signal;
a filter connected to said coupler and used for filtering out noise of said signal;
an IC connected to said filter and used for transmitting said signal; and
a microprocessor connected to said IC and having a program for controlling actions of said IC.

2. The time division multiple access over voice line as claimed in claim 1, wherein said coupler couples said signal to said telephone line or a voice line.

3. The time division multiple access over voice line as claimed in claim 1, wherein said IC is formed by integrating several electronic circuits.

4. The time division multiple access over voice line as claimed in claim 1, wherein said communication equipment provides at least a data box to store said telephone line signal.
